(19) United States
(12) Patent Application Publication
(10) Pub. No.: US 2020/0046001 A1
(43) Pub. Date: Feb. 13, 2020

(54) AQUAFABA PRODUCTS AND METHODS

(71) Applicant: ALTERNATIVE FOODS LONDON LTD., London (GB)

(72) Inventor: Hannah Carter, London (GB)

(21) Appl. No.: 16/537,175

(22) Filed: Aug. 9, 2019

(30) Foreign Application Priority Data
Aug. 9, 2018 (GB) 1813006.2
Apr. 23, 2019 (GB) 1905674.6

(51) Int. Cl. A23L 11/00; A23L 15/00; A23L 5/10; A23B 7/06

(52) U.S. Cl. CPC A23L 11/05; A23L 15/35; A23V 2002/00; A23L 5/13; A23B 7/06; A23L 5/17

(57) ABSTRACT

Packaged aquafaba having a protein content by weight of at least 0.5%. The packaged aquafaba is provided in liquid form and packaged in a pouch. Methods of making aquafaba and of using aquafaba and the products resulting therefrom are also disclosed.

### FIELD

The present disclosure generally relates to aquafaba products and methods of making and using aquafaba. More particularly, the present disclosure relates to aquafaba, baked goods made using aquafaba, meringue made using aquafaba and methods of manufacturing aquafaba.

### BACKGROUND

Aquafaba is legume brine, most commonly, but not limited to, chickpea brine.

Aquafaba has been used to replace egg, particularly, egg whites in some sweet and savory recipes. Aquafaba contains starches, proteins, and other soluble plant solids that have migrated from legumes to water during the cooking process.

Baked goods and meringues have been made using aquafaba as an egg substitute. Typically, aquafaba is obtained by keeping the liquid from a can of legumes or is made through traditionally chickpeas being soaked overnight or boiled in a saucepan. The functional effectiveness of the aquafaba as an egg substitute in various cooking applications; whether from a can or home-made; is inconsistent from batch to batch, brand to brand and legume to legume. Experience shows that sometimes the aquafaba liquid functions adequately as an egg substitute and sometimes it does not function well.

Accordingly, it is desirable to develop a consistently, stable and functionally effective aquafaba as an egg substitute in various cooking applications and the methods of obtaining such aquafaba in a repeatable and reliable way. In addition, it is desirable to provide consumers with aquafaba more conveniently. Furthermore, other desirable features and characteristics of the present invention will become apparent from the subsequent detailed description of the invention and the appended claims, taken in conjunction with the accompanying drawings and the background of the invention.

### SUMMARY

In one aspect, packaged aquafaba is provided having a protein content by weight of at least 0.5%.

In one aspect, packaged aquafaba is provided having a total polysaccharide content by w/w of at least 15%

In another aspect, packaged aquafaba is provided having a protein content by weight of at least 0.5% and a total polysaccharide content by weight of at least 15%.

It has been found by the present inventors that ensuring a sufficient minimum of protein content in the aquafaba allows for acceptable egg substitute function in various cooking applications.

It has further been found by the present inventors that ensuring a sufficient minimum of polysaccharide content in the aquafaba allows for acceptable egg substitute function in various cooking applications. Providing packaged aquafaba separated from legumes having a minimum protein content and combined polysaccharide content ensures a reliable supply of aquafaba for consumers.

Experiments have shown that there are varied combinations of percentages of protein (P) and polysaccharides (PS) w/w (weight by weight), that result in an effective aquafaba which include, but are not limited to: 35% PS with 30% protein, 40% PS with 30% protein, 45% PS with 30% protein, 50% PS with 30% protein, 55% PS with 30% protein, 60% PS with 30% protein, 65% PS with 30% protein, 70% PS with 30% protein, 35% PS with 25% protein, 40% PS with 25% protein, 45% PS with 25% protein, 50% PS with 25% protein, 55% PS with 25% protein, 25% PS with 25% protein, 25% PS with 25% protein, 25% PS with 25% protein, 35% PS with 25% protein, 40% PS with 25% protein, 45% PS with 20% protein, 50% PS with 20% protein, 55% PS with 20% protein, 60% PS with 20% protein, 65% PS with 20% protein, 70% PS with 20% protein, 35% PS with 40% protein, 40% PS with 40% protein, 45% PS with 40% protein, 50% PS with 40% protein, 55% PS with 40% protein, 60% PS with 40% protein, 65% PS with 40% protein, 70% PS with 40% protein, 35% PS with 50% protein, 45% PS with 50% protein, 50% PS with 50% protein, 55% PS with 50% protein, 60% PS with 50% protein, 65% PS with 50% protein, 70% PS with 50% protein,

The packaging is provided by sealing (e.g. airtight to preserve freshness) the aquafaba in the packaging, in some embodiments. Various packaging sizes are contemplated from end consumer size packaging (e.g. 100 ml to 1 liter) to industrial packaging (e.g. 5 or 10 or more liters) for use of aquafaba in further manufacturing.

In embodiments, the aquafaba is liquid aquafaba, e.g. only liquid. That is, in some examples, the aquafaba does not include whole legume solids/seeds. There may, however, be some sedimentary matter as allowed by pore size of drainer used to separate legume solids from liquid.

In embodiments, the aquafaba is packaged in a pouch or carton. The pouch or carton is a retort pouch or carton in some embodiments to ensure freshness and extend the shelf life. In embodiments, the package is for end consumers. In other embodiments, the package, such as a barrel, is for further manufacturing use

In embodiments, the aquafaba comprises water in which legumes have been cooked, wherein the legumes are selected from the group consisting of chickpeas, butter beans, haricot beans, black beans, red kidney beans, cannellini beans, navy beans, mung beans, pinto and combinations thereof. It has been found that these legumes, and not soy beans, are particularly suitable for egg substitute in terms of function without an overpowering bean taste being imparted on the cooked product, which is particularly relevant for sweet end products.

In embodiments, the aquafaba comprises water in which legumes have been cooked, the legumes selected from the group consisting of chickpeas, butter beans and cannellini beans and combinations thereof. Again, these bean types have been found to be provide particularly high performing aquafaba in various cooking applications. Of particular interest is chickpeas or a combination of butter beans and chickpeas for making meringue and cannellini beans for making baked goods (such as sponge-based baked goods).

In embodiments, the aquafaba comprises water in which a combination of at least two different legumes have been cooked, a first of the legumes being present in a ratio relative to a second of the legumes in any of the ranges 80% to 20%, 70% to 30%, 60% to 40%, 55% to 45% and 50%. In other examples, just one type of legume is used, such as chickpea.

In embodiments, the aquafaba has a protein content of at least: 0.5%, 0.60%, 0.7%, 0.8%, 0.9%, 1.0%, 1.1%, 1.2%, 1.3%, 1.4%, 1.5% or 1.6%. Processing the legumes (e.g. extra cooking) to produce aquafaba with higher protein content can be useful for structural integrity of resulting cooked products but there is a trade-off in terms of cooking times and disintegration of the legumes during cooking. Hence, in embodiments, the aquafaba has a protein content of up to 3%, 2.9%, 2.8%, 2.7% or 2.6%.

In embodiments, the aquafaba has a total polysaccharide content of at least % w/w: 15%, 20%, 25%, 30%, 35%, 40%, 45%, 50%, 55%, 60%, 65%, 70%, 75%, 80%.

In embodiments, combinations of total protein content and total polysaccharide content are provided that include at least 0.50% protein and at least 15% PS, at least 0.60% protein and at least 20% PS, at least 0.7% protein and at least 25% PS, at least 0.8% protein and at least 30% PS, at least 0.9% protein and at least 35% PS, at least 1.0% protein and at least 40% PS, 1.1% protein and at least 45% PS, at least 1.2% protein and at least 45% PS, at least 1.3% protein and at least 50% PS, at least 1.4% protein and at least 50% PS, etc. That is, each of the various minimums for protein content described herein are combinable with each of the various minimums for polysaccharide content described herein, in any way.

In embodiments that have shown positive results in terms of stable foaming aquafaba, the total polysaccharide content is 40% to 70% in the material soluble in water (supernatant, SN) and 30%-75% in the material insoluble (precipitate/residue, PP) and the protein content is between 20%-35% in the supernatants and 40%-60% in the precipitates/residue. It is postulated that proteins are usually required for foaming production, but the polysaccharides are responsible for the foam stability. Such protein content and polysaccharide content values can be achieved by making the aquafaba according to various methods with the presently disclosed goal of controlling the production to achieve such goals (which may involve some manageable trial and error) or the herein described manufacturing methods can be followed and optimized to achieve such values, or a combination of both possibilities can be followed.

The polysaccharides included in the aquafaba can be any one or more of rhamnose, fucose, ribose, arabinose, xylose, mannose, galactose and glucose. The polysaccharides comprise mainly arabinose, galactose and glucose as the main component, with rhamnose and xylose present in lower amounts, as well as fucose, ribose and mannose (vestigial amounts).

In another aspect, a method of manufacturing aquafaba is provided. The method includes pressure cooking legumes in water, separating the water from the legumes to obtain aquafaba, and optionally packaging the aquafaba. In this way, a reliably stable source of aquafaba is provided to consumer, chefs and manufacturers.

In embodiments, the pressure cooking is performed for at least 30 minutes, at least 35 minutes, at least 40 minutes, at least 45 minutes, at least 50 minutes, at least 60 minutes, at least 65 minutes, at least 70 minutes, at least 75 minutes or at least 80 minutes. Pressure cooking allows extraction of protein from the legumes into the cooking water. The longer the cook, the greater the protein content (generally, with other factors being equivalent). It is also desirable to reduce processing times such that the pressure cooking is performed for less than (or equal to) 120 minutes, less than 100 minutes, less than 90 minutes, less than 80 minutes, less than 70 minutes or less than 60 minutes. Pressure cooking includes simmering or boiling the legumes for these times.

In embodiments, the legumes are selected from the group consisting of chickpeas, butter beans, haricot beans, black beans, red kidney beans, cannellini beans and combinations thereof. In embodiments, the legumes are selected from the group consisting of chickpeas, butter beans and cannellini beans and combinations thereof. In embodiments, the legumes comprise a combination of at least two different legumes, a first of the legumes being present in a ratio relative to a second of the legumes in any of the ranges 80% to 20%, 70% to 30%, 60% to 40%, 55% to 45% and 50%.

In embodiments, the method includes protein analyzing the aquafaba. By including a protein analysis in the manufacturing process, stability of the aquafaba can be ensured. In embodiments, the method includes discarding aquafaba not having a predefined minimum protein content. In embodiments, the predefined minimum protein content is at least: 0.5%, 0.6%, 0.7%, 0.8%0.9%, 1.0%, 1.1%, 1.2%, 1.3%, 1.4%, 1.5% or 1.6%. In addition, the method can include controlling the process so that the aquafaba has a total polysaccharide content of at least % w/w: 15%, 20%, 25%, 30%, 35%, 40%, 45%, 50%, 55%, 60%, 65%, 70%, 75%, 80%.

In embodiments, a weight ratio of legumes to water in the pressure-cooking step is 10% to 50%, 10% to 40%, 10% to 30% or 10% to 25%. Such ratios have been found to provide relatively high performing aquafaba.

In embodiments, pressure cooking is performed at a pressure of 100 to 6000 millibar, 150 to 4000 millibar, 150 to 3000 millibar or 150 to 2500 millibar. The pressure in the pressure-cooking step is selected to enable the denaturing proteins but not the breaking of; whilst ensure a sufficiently quick cook time. In embodiments, a cook time for the pressure-cooking step of 45 to 120 minutes is used, optionally 60 to 90 minutes.

In embodiments, the pressure-cooking step is performed at be at a temperature of less than 200° C. and more than 100° C. In embodiments, the temperature is greater than 110° C. and less than 190 or 185° C.

In embodiments, the method includes a step of blanching the legumes prior to pressure cooking. In some embodiments, the blanching step comprises placing the legumes in hot water at or near boiling point (at least 80° C., 90° C., or about 100° C.) and the pressure cooking step is performed in a different batch of water. In other embodiments, a blanch step is not used.

In embodiments, the process includes retorting the aquafaba at above 1 Bar of pressure and at a temperature between 110-230 degrees after pressure cooking and prior to packaging. In other embodiments, a retort step is not used 1

In embodiments, the aquafaba described herein is used to make an egg-free baked good. In one aspect, the egg-free baked good is provided. In embodiments, the egg-free baked good is sponge-based such as muffins and sponge cakes.

In embodiments, the aquafaba described herein is used to make egg-free meringue. In another aspect, the egg-free meringue is provided. Meringue is another example of a baked good.

In some embodiments, the afore-described method does not include a packaging step and the method continues to using the aquafaba in making egg-free meringue or other baked goods.

In embodiments, the use includes adding an acid additive, which provides a stiffening agent to enhance the cooked product. In embodiments, the acid additive is apple cider vinegar or cream of tartar. In embodiments, the acid additive is added in an amount of less than 2% or 1.5% or wherein the acid additive is added in an amount of greater than 0.15%. The acid is generally added to the aquafaba during a whisking step of making meringue, sponge or other baked goods.

### BRIEF DESCRIPTION OF THE DRAWINGS

The present invention will hereinafter be described in conjunction with the following drawing figures, wherein like numerals denote like elements, and

FIG. 1 is a flow chart of a method of producing aquafaba, in accordance with various embodiments; and

FIG. 2 is a flow chart of a method of making meringue, in accordance with various embodiments.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

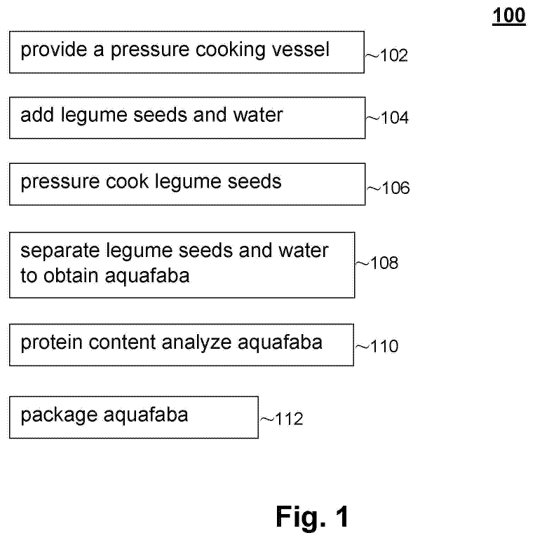

FIG. 1 is a flow chart illustrating a method 100 of manufacturing aquafaba, in accordance with an example embodiment. The method of FIG. 1 is a batch process as an example embodiment. In-line processes are used in alternative embodiments.

At 102, a pressure cooking vessel is provided. In embodiments, the pressure cooking vessel includes an integrated stirrer and a drain function to remove liquids whilst leaving solids in a kettle. The pressure cooking vessel maintains the kettle in an air tight and liquid tight condition to minimize water loss. The pressure cooking vessel operates in the range of pressures 150 to 2500 millibar or 2000 millibar in some examples. One example suitable pressure cooking vessel is a Firex Cucimax CBT 310A V1, which has a 310 liter kettle.

At 104, legumes and water are added to the kettle of the pressure cooking vessel. In the present embodiment, example legumes are chick peas, butter beans and cannellini beans and combinations thereof. However, other legumes have been found to be effective as has been described heretofore. The legumes can be dried or soaked. A water content of the legumes (which may or may not be a mix of different types) and water is in the range 10% to 25% legumes and 90% to 75% water, by weight, in some embodiments. It should be appreciated that for soaked legumes, weight of the water in the beans is to be included in the overall weight of water in the kettle of the pressure cooking vessel.

In some embodiments, prior to step 104, the legumes (e.g. chickpeas) are prepared by blanching of the legumes at between 80 to 100 degrees ° C. for up to 30 minutes. After the blanching step, the legumes are separated from the blanching water (e.g. drained) and provided in the pressure-cooking vessel.

At 106, the legumes and water are pressure cooked. In one example embodiment, pressure cooking is performed at 200 millibar and for 45 to 100 minutes (e.g. about 60 minutes). The water is boiled or simmered and the pressure-cooking vessel maintains a set pressure. Optimal pressure-cooking conditions for obtaining effective aquafaba include a variety of factors such as the type of legumes and the type of pressure-cooking vessel. Generally, pressure-cooking is performed at a pressure between 0.3 bar and 6 Bar and for 45-120 minutes and at a temperature of between 110° C. and 185° C.

At 108, legumes and water are separated. In embodiments, a tilting function of the pressure-cooking vessel is used and a drain valve is used to separate the water from the legumes. The cooked legumes can be repurposed for other products. The separated water is aquafaba. In some embodiments, the yield of water in to the process 100 to aquafaba out of the process 100, by weight, is between 50% and 80%.

In embodiments, a retorting step is included in the process after step 108 to maximize product lifetime. The retorting step has a sterilization function. In embodiments, retorting is performed on the aquafaba at above 2 Bar of pressure and at a temperature of between 110-230 degrees. In other embodiments, retorting is not used

At 110, protein content of the aquafaba produced in step 108 is analyzed to ensure a sufficient protein content. The optimal protein content depends to some extent on the cooking application for the aquafaba and the type of legumes. Exemplary protein content minimums for chickpeas are, by weight, 1.1%, 1.2%, 1.3%, 1.4%, 1.5% and 1.6%. Exemplary protein content minimums for butter beans are 0.8%, 0.9%, 1.0%, 1.1% and 1.2%. Exemplary protein content minimums for cannellini beans are 2.2%, 2.3%, 2.4%, 2.5% and 2.6%. At 110, polysaccharide content of the aquafaba is controlled to ensure a sufficient minimum thereof, according to the minimums described above. Exemplary parameters for adjusting the process 100 to ensure minimum protein and polysaccharide content are achieved include water content in step 104 and pressure, temperature and cook time in step 106. According to the present disclosure, optimal parameters are established based on trial and error using protein analysis and polysaccharide feedback for a given process and cooking set-up to ensure effective aquafaba is achieved consistently. Once the process has been set up to consistently achieve the minimum protein content and optionally the minimum polysaccharide content, testing of each further batch is not required (although it may be performed periodically to ensure set standards are being maintained).

In some embodiments, step 110 includes testing of each batch of aquafaba (or continuous testing in in-line processes) to ensure the protein content (and optional polysaccharide) goal is achieved and discarding any batches when the minimum protein content is not achieved. However, for suitably optimized processes, all batches may achieve the minimum protein content without requiring batch by batch testing (or continuous testing) and discarding.

At 112, the method 100 includes, in some embodiments, packaging the aquafaba liquid. In one exemplary embodiment, packaging includes filling and sealing a pouch or carton. However, canned and other packaging are envisaged, such as a barrel or other industrial vessel where the aquafaba is to be used in a subsequent manufacturing process rather than being supplied for end consumers. The pouch or carton is a retort pouch or carton in some embodiments. Retort packages allow freshness of the aquafaba to be maintained without requiring chilling at each stage of the supply chain, extending the shelf life. Filling of the pouch can be performed by hot filling in some examples. Such packaging is suitable for end-consumers and can include 100 ml packages to 1000 ml packages. Where the next user is a manufacturer (e.g. meringue or sponge maker), larger packaging is used such as at least 5 liters. In such embodiments, tubs or barrels are used for packaging and the aquafaba is preserved by keeping the tubs or barrels chilled. In some embodiments, step 112 is not performed and the aquafaba liquid is moved directly onto the next step in a manufacturing process such as making meringue or other baked goods.

In one specific example of method 100, 10 kilograms of dried chickpeas were added to the pressure cooking vessel in step 104 along with 75 kilograms of water. The beans were cooked for 40 minutes at 200 millibar, resulting in 24 kilograms of cooked chick peas and 56.6 kilograms of aquafaba. The protein content of the aquafaba was found to be 1.63% and thus fulfilled a set minimum protein content of 1.2%. The minimum protein content was set based on meringue quality, e.g. texture and flavor, assessments.

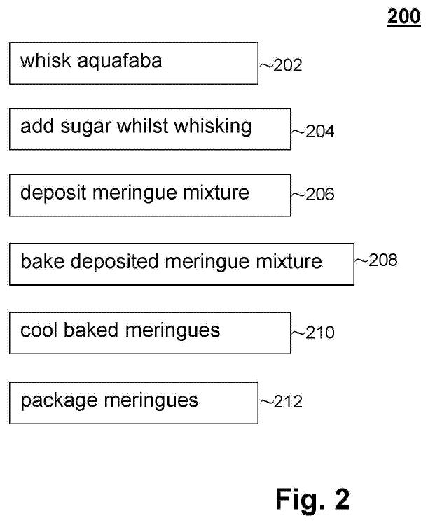

FIG. 2 is a flow chart illustrating a method 200 of making egg-free meringue using aquafaba produced as hereinbefore described, in accordance with an exemplary embodiment.

At 202, the aquafaba is whisked until stiff peaks are formed. In embodiments, an electrical whisking or whipping device is used. In one example, the whisking step takes 5 to 25 minutes, 10 to 20 minutes or about 15 minutes. In accordance with various embodiments, chickpea based aquafaba or a combination aquafaba of chickpeas and butter beans is used. Accordingly, at least 30%, 40%, 50%, 60%, 70%, 80%, 90% or 100% of the legumes, by weight, used in method 100 are chickpeas with the balance (if any) being butter beans to produce aquafaba for method 200 that has been found to result in comparable consistency and flavor meringues to those using egg whites. This type of aquafaba is merely by way of example. For example, cannellini beans (alone or in combination with other legumes seeds) could be used. 100% butter beans aquafaba has also been found to produce effective egg-free meringue.

In some embodiments, an acid additive is added at step 202 as a stiffening agent. Exemplary acid additives include cream of tartar and apple cider vinegar, amongst others. When a combination of butter bean and chickpea aquafaba is used, apple cider vinegar is used, in one embodiment, for meringue texture and flavor reasons. When chickpea aquafaba is used, cream of tartar is used, in an embodiment, for meringue texture and flavor reasons. In embodiments, the acid additive is added in an amount of less than 2% or 1.5% and the acid additive is added in an amount of greater than 0.15% relative to, by weight, the other meringue ingredients (sugar and aquafaba).

At 204, sugar is gradually added to the aquafaba and whisked (e.g. whisking of step 202 is continued). In embodiments, sugar forms at least 50%, by weight, of the meringue ingredients and up to 70%, with about 60% sugar and about 40% aquafaba being used in one example. Whisking continues until a suitable meringue consistency is obtained. Whisking can take place for at least 5 minutes and up to 50 minutes and at least 20 minutes and up to 40 minutes.

At 206, the meringue mixture from 204 is deposited onto a baking tray. Depositing can be through a piping bag in low quantity applications or using an electrical depositor for larger scale applications. The baking tray can be plain or include forms for each meringue.

At 208, the deposited meringues from step 206 are baked until ready. In embodiments, a fan assisted oven is used at a temperature from 70° C. to 150° C., particularly about 100° C. It has been found that high quality meringues are obtained using cooking times of from 40 minutes to 120 minutes, particularly 50 minutes to 100 minutes and more particularly 55 minutes to 95 minutes.

At 210, the meringues from step 208 are allowed to slowly cool. In one embodiment, the meringues remain in the oven during cooling with the oven switched off.

At 220, the baked and cooled meringues are packaged suitably, e.g. for sale to end consumers.

Aquafaba described herein is useful in accordance with other embodiments for making egg-free baked goods such as sponges, muffins, pastry, Yorkshire pudding, meringues and non-baked goods such as mousse or dairy-free butter. It has been found that cannellini beans aquafaba (e.g. including at least about 40%, 50%, 60%, 70%, 80%, 90% or 100% cannellini beans in the legumes used to make the aquafaba) is particularly apt for producing sponge that is comparable to egg sponges in both texture and flavor. In embodiments, the aquafaba is first whipped until stiff peaks form, optionally with addition of acid as described hereinbefore, before adding the whipped aquafaba to other sponge ingredients for mixing.

While at least one exemplary aspect has been presented in the foregoing detailed description of the invention, it should be appreciated that a vast number of variations exist. It should also be appreciated that the exemplary aspect or exemplary aspects are only examples, and are not intended to limit the scope, applicability, or configuration of the invention in any way. Rather, the foregoing detailed description will provide those skilled in the art with a convenient road map for implementing an exemplary aspect of the invention. It being understood that various changes may be made in the function and arrangement of elements described in an exemplary aspect without departing from the scope of the invention as set forth in the appended claims.

What is claimed is:

1. Packaged aquafaba having a protein content by weight by weight of at least 0.5%.

2. Packaged aquafaba according to claim 1 having a total polysaccharide content weight by weight of at least 15%

3. Packaged aquafaba according to claim 1 being packaged liquid aquafaba, wherein the liquid aquafaba has all beans removed therefrom.

4. Packaged aquafaba according to claim 1 being packaged in a pouch.

5. Packaged aquafaba according to claim 1 wherein the aquafaba comprises separated water in which legumes have been cooked, wherein the legumes are selected from the group consisting of chickpeas, butter beans, haricot beans, black beans, red kidney beans, cannellini beans, navy beans, mung beans, pinto beans and combinations thereof.

6. Packaged aquafaba according to claim 5 wherein the aquafaba comprises separated water in which legumes have been cooked, the legumes selected from the group consisting of chickpeas, butter beans and cannellini beans, navy beans, mung beans, pinto beans and combinations thereof.

7. Packaged aquafaba according to claim 1, wherein the aquafaba comprises separated water in which chick peas have been cooked.

8. Packaged aquafaba according to claim 1 having a protein content of at least: 0.50%, 0.60%, 0.7%, 0.8%, 0.9%, 1.0%, 1.1%, 1.2%, 1.3%, 1.4%, 1.5% or 1.6%.

9. Packaged aquafaba according to claim 2 having a polysaccharide content of at least: 15%, 20%, 25%, 30%, 35%, 40%, 45%, 50%, 55%, 60%, 65%, 70%, 75%, 80%

10. A method of manufacturing aquafaba, comprising:
pressure cooking legumes in water;
separating the water from the legumes to obtain aquafaba; and
optionally packaging the aquafaba.

11. The method of claim 10, wherein the pressure cooking is performed for at least 30 minutes, at least 35 minutes, at least 40 minutes, at least 45 minutes or at least 60 minutes at pressure.

12. The method of claim 10, wherein the pressure cooking is performed for less than or equal to 120 minutes, 100 minutes, 90 minutes, 80 minutes or 70 minutes, 60 mins, 50 mins, 40 mins, 30 mins, 20 mins at pressure

13. The method of claim 10, wherein the legumes are selected from the group consisting of chickpeas, butter beans, haricot beans, black beans, red kidney beans, cannellini beans, navy beans, mung beans, pinto beans and combinations thereof.

14. The method of claim 10, wherein a weight ratio of legumes to water in the pressure-cooking step is 10% to 50%, 10% to 40%, 10% to 30% or 10% to 25%.

15. The method of claim 10, wherein pressure cooking is performed at a pressure of 100 to 6000 millibar, 150 to 4000 millibar, 150 to 3000 millibar or 150 to 2500 millibar.

16. The method of claim 10, comprising a retorting step for the aquafaba prior to the packaging step.

17. The method of claim 10, wherein the protein content of the aquafaba is at least 0.5%.

18. The method of claim 10, comprising a step of blanching the legumes prior to pressure cooking.

19. Using the aquafaba of claim 1 to make at least one of: an egg-free baked/cooked good and an egg-free meringue.
